(19) United States
(12) Patent Application Publication
(10) Pub. No.: US 2015/0100447 A1
(43) Pub. Date: Apr. 9, 2015

(54) SYSTEM AND METHOD FOR SELLING ITEMS WON IN A BIDDING FEE AUCTION

(71) Applicant: Fleezip Inc., Saint-Laurent (CA)

(72) Inventor: Max BOHBOT, Montreal (CA)

(73) Assignee: Fleezip Inc., Saint-Laurent (CA)

(21) Appl. No.: 14/046,550

(22) Filed: Oct. 4, 2013

(51) Int. Cl. G06Q 30/08

(52) U.S. Cl. CPC G06Q 30/08
USPC 705/26.3

(57) ABSTRACT

A system for selling items won in an auction provides a bidding fee auction for an item and receives one or more bids for the item. The system determines a winning bidder based on the received one or more bids and generates a user interface providing the winning bidder a first option to purchase the item at a purchase price calculated based on the one or more bids, and a second option to list the item for sale in an electronic marketplace. The system receives a selection including the first option or the second option. When the selection includes the first option, the system initiates payment processing for the item. When the selection includes the second option, the system generates a user interface requesting a listing price for the item, receives the listing price in response to generating the user interface requesting the listing price, and verifies the received listing price. The system generates a listing including a description of the item and the listing price.

### BACKGROUND

The popularity of wide area networks, such as the Internet, for buying and selling items has led to an increase in computer systems offering electronic auctions. In a traditional electronic auction, bidders operate a computer that provides a user interface including item information and one or more user interface elements enabling users to place a bid on an item. For example, a traditional electronic auction can be offered through a website or client side computing application configured to execute on a user's computer that provides current price information, a description of the auctioned item, and interactive elements allowing a user to enter and submit a bid for the item. Generally, items for auction are listed by users that are private sellers or merchants. The bidder that places the highest bid for an item wins an option to purchase the item for the highest bid from the selling user, while bidders that do not win the auction pay nothing for placing their bid.

The popularity of the Internet and traditional electronic auctions has given rise to electronic bidding fee auctions. A bidding fee auction (sometimes referred to as a “penny auction”) is an auction where all bidders pay a non-refundable fee to place a small incremental bid on an item listed for auction. A bidding fee auction includes several bidding periods that are reset upon the placement of a bid and are generally short in length. When the time period expires without a new bid, the last bidding user wins the auction item. For example, a television might be offered in a bidding fee auction with periods of ten seconds, bid increments of $0.01, and a starting price of $0.00. When the auction begins, the timer starts. A first bid on the television increases the price to $0.01 and the ten second timer resets and begins again. A second bid on the television increases the price to $0.02 and the ten second time resets and begins again. If there are no other bids on the television, the bidder placing the second bid will win the auction and the right to claim the television for $0.02. If, however, there is a third bid on the television, the price will increase to $0.03 and the ten second timer will again be reset. Typically, the final price of an item in a bidding fee auction is much lower than the retail price of an item, making bidding fee auctions attractive to bidders. In some bidding fee auctions, bidders buy bids that are used for the auction, and the price of the bid may not be the same as the bid increment for the auctions. For example, a bid may cost $0.02 and the bid increment may be $0.01 or $0.04. Also, some websites offering bidding fee auctions allow users to purchase bids in bulk, award free bids, or provide bids as promotional items.

### SUMMARY

In one aspect, a system for selling items won in a bidding fee auction includes a processor configured to provide a bidding fee auction for an item and receive one or more bids for the item. The processor is further configured to determine a winning bidder based on the received one or more bids and to generate a user interface providing the winning bidder a first option to purchase the item at a purchase price calculated based on the one or more bids, and a second option to list the item for sale in an electronic marketplace. The processor is also configured to receive a selection including the first option or the second option. When the selection includes the first option, the processor initiates payment processing for the item. When the selection includes the second option, the processor generates a user interface requesting a listing price for the item, receives the listing price in response to generating the user interface requesting the listing price, and verifies the received listing price. The processor generates a listing including a description of the item and the listing price.

In another aspect a method for selling items won in a bidding fee auction includes providing a bidding fee auction for an item and receiving one or more bids for the item. The method further includes determining a winning bidder based on the received one or more bids and generating a user interface providing the winning bidder a first option to purchase the item at a purchase price calculated based on the one or more bids, and a second option to list the item for sale in an electronic marketplace. The system receives a selection including the first option or the second option. When the selection includes the first option, payment processing for the item is initiated. When the selection includes the second option, a user interface is generated requesting a listing price for the item, the listing price is received and verified. The method further includes generating a listing including a description of the item and the listing price.

### BRIEF DESCRIPTION OF THE DRAWINGS

Reference will now be made to the accompanying drawings which illustrate exemplary embodiments of the present disclosure and in which:

FIG. 1A illustrates, in block form, an exemplary system for selling items won in a bidding fee auction, consistent with disclosed embodiments.

FIG. 1B illustrates, in block form, an exemplary system for selling items won in a bidding fee auction, consistent with disclosed embodiments.

FIG. 2 is a block diagram of an exemplary computer system with which embodiments of the present disclosure can be implemented.

FIG. 3 is a flowchart representing an exemplary process for listing an item won in bidding fee auction, consistent with the embodiments of the present disclosure.

FIG. 4 is a flowchart representing an exemplary process for modifying an item listing, consistent with the embodiments of the present disclosure.

FIG. 5 is a flowchart representing an exemplary process for purchasing an item, consistent with the embodiments of the present disclosure.

FIG. 6 is a screenshot of an exemplary depiction of a graphical user interface, consistent with embodiments of the present disclosure.

FIG. 7 is a screenshot of an exemplary depiction of a graphical user interface, consistent with embodiments of the present disclosure.

FIG. 8 is a screenshot of an exemplary depiction of a graphical user interface, consistent with embodiments of the present disclosure.

FIG. 9 is a screenshot of an exemplary depiction of a graphical user interface, consistent with embodiments of the present disclosure.

FIG. 10 is a screenshot of an exemplary depiction of a graphical user interface, consistent with embodiments of the present disclosure.

FIG. 11 is a screenshot of an exemplary depiction of a graphical user interface, consistent with embodiments of the present disclosure.

### DETAILED DESCRIPTION

Reference will now be made in detail to exemplary embodiments of systems and methods for commentary analysis, examples of which are illustrated in the accompanying drawings. Wherever possible, the same reference numbers will be used throughout the drawings to refer to the same or like parts. The terminology used in the description presented herein is not intended to be interpreted in any limited or restrictive manner, simply because it is being utilized in conjunction with a detailed description of certain specific embodiments. Furthermore, the described embodiments may include several novel features, no single one of which is solely responsible for its desirable attributes or which is essential to the systems and methods described herein.

### Overview

As noted above, bidding fee auctions can be attractive to bidders because they can often win the right to purchase an item at a price that is much lower than the retail price or typical sale price of the item. For example, a computer worth $1000 can be purchased in a bidding fee auction for $150. Skilled bidders can strategically manage their bids such that the cost of purchasing the item plus the cost of their bids results in a final cost that is much lower than the retail price or typical sale price of the item. For example, a bidder can win an auction for a computer worth $1000 with a winning bid amount of $150 while only incurring $100 in bid costs. As a result, the bidder can obtain a computer worth $1000 for $250.

Conventional electronic bidding fee auctions, however, are limited in that bidders must pay for and take delivery of the items to realize savings. For example, a skilled bidder that pays $250 (including bid costs) for a $1000 computer will have to pay the operator of the electronic bidding fee auction $150 to claim the computer. If the skilled bidder desires to resell the item, she will have to take delivery of the computer, which could increase acquisition costs (e.g., because of shipping) and minimize potential savings or profit. In addition, when the skilled bidder is interested in reselling the item for profit, she is likely to incur additional costs and inconveniences associated with identifying a platform (e.g., a traditional electronic auction, classified list, brick-and-mortar marketplace) for selling the item.

Accordingly, the embodiments disclosed herein provide a system and method for selling items won in a bidding fee auction. The disclosed embodiments provide an electronic marketplace where users that have won a bidding fee auction (“winning bidders”), can re-list the item they have won for resale without having to take delivery of the item and, in some cases, without having to pay the winning bid amount for the item before selling the item. For example, bidders can bid on a television worth $1500 that is offered in a bidding fee auction. The auction ends with a winning bid amount of $300, and the winning bidder incurred $200 in bid costs. When the auction ends, a computer system providing the bidding fee auction can generate a user interface providing the winning bidder with an option of claiming the television for $300 or listing the item in an electronic marketplace. The winning bidder can choose a price to list the item in the electronic marketplace that generates a profit for her, provided the chosen price satisfies the pricing criteria of the electronic marketplace. For example, the winning bidder can choose to list the television for $750 in the marketplace. As the listing price of $750 is lower than the $1500 retail price for the television, and higher than the winning bid amount of $300 plus $200 in bid costs, the winning bidder is likely to make a profit on the sale of the computer while still offering the computer at a price attractive to potential buyers likely resulting in a quick sale. In some embodiments, the computer system providing the bidding fee auction can generate a user interface providing the winning bidder with an option of receiving a redemption value for the won item instead of claiming the item or listing it in the electronic marketplace. For example, the computer system providing the bidding fee auction can offer to purchase the television from the winning bidder for $600. As the redemption value of $600 is higher than the winning bid amount of $300 plus $200 in bid costs, the winning bidder can realize profit without listing the product for sale in the electronic marketplace. Additional objects and advantages of disclosed embodiments will be set forth in part in the descriptions of example systems, processes, and user interfaces which follow, and in part will be obvious from the description, or may be learned by practice of the systems and methods. The objects and advantages of the disclosed embodiments can be realized and attained by means of the elements and combinations particularly pointed out in the appended claims. It is to be understood that both the foregoing overview and the following descriptions are exemplary and explanatory only. The accompanying drawings, which are incorporated in, and constitute a part, of this specification, illustrate several embodiments and together with the description serve to explain the principles of systems and methods for selling items won in a bidding fee auction.

### Description of Example Systems

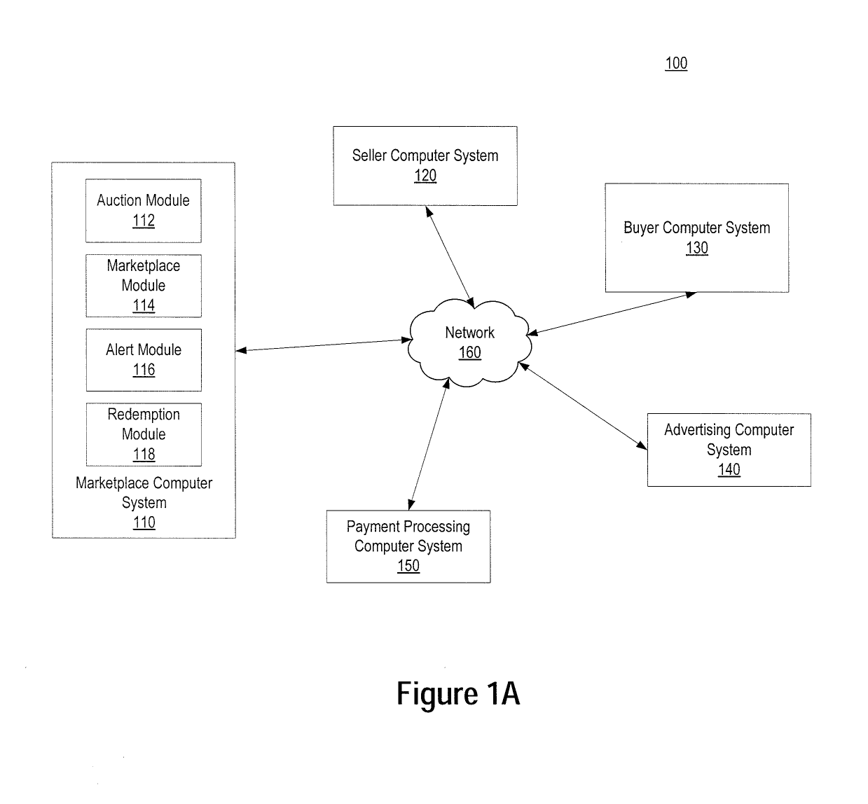

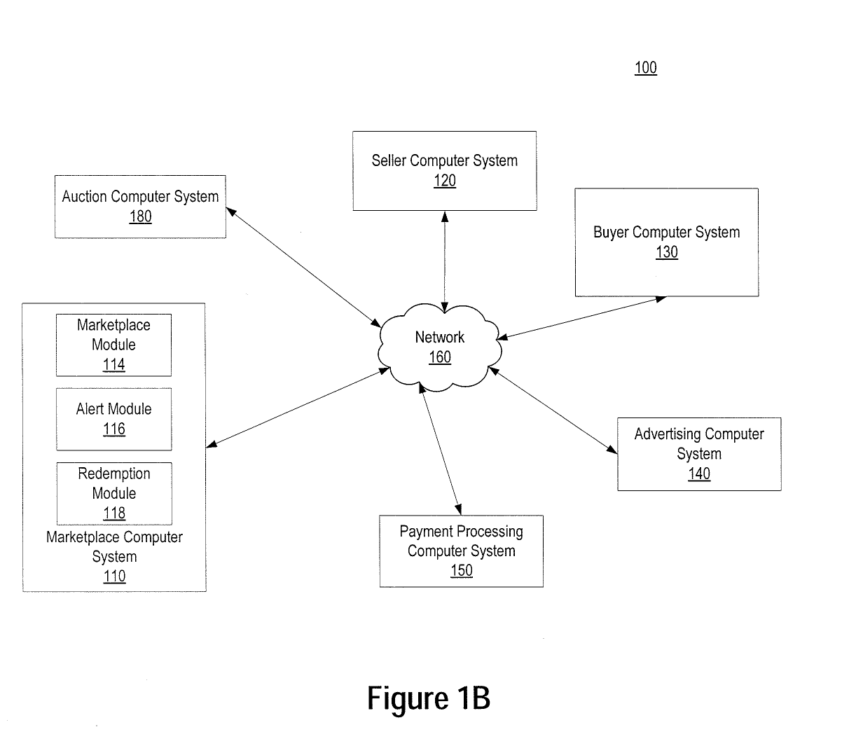

FIG. 1A illustrates, in block form, a system 100 for selling products won in a bidding fee auction, consistent with disclosed embodiments. In the embodiment illustrated in FIG. 1A, marketplace computer system 110 can communicate with seller computer system 120, buyer computer system 130, advertising computer system 140, and payment processing computer system 150 across network 160.

System 100 outlined in FIG. 1A can be computerized, wherein each of the illustrated components comprises a computing device that is configured to communicate with other computing devices via network 160. For example, seller computer system 120 can include a computing device, such as a desktop, notebook, or handheld computing device that is configured to transmit and receive data to/from other computing devices via network 160. Similarly, marketplace computer system 110, buyer computer system 130, advertising computer system 140, and payment processing computer system 150 can include one or more computing devices that are configured to communicate data via the network 160. Depending on the embodiment, network 160 can include one or more of any type of network, such as one or more local area networks, wide area networks, personal area networks, telephone networks, and/or the Internet, which can be accessed via any available wired and/or wireless communication protocols. For example, network 160 can comprise an Internet connection through which marketplace computer system 110 and seller computer system 120 communicate. Any other combination of networks, including secured and unsecured network communication links are contemplated for use in the systems described herein.

In some embodiments, marketplace computer system 110 communicates, using network 160 for example, with seller computer system 120 and buyer computer system 130 to perform operations consistent with embodiments disclosed herein. According to some embodiments, marketplace computer system 110 can provide one or more websites accessible by seller computer system 120 and buyer computer system 130 that offer items in bidding fee auctions, and seller computer system 120 and buyer computer system 130 can access the websites so users of the systems can place bids on auctioned items. In addition, marketplace computer system 110 can provide one or more websites accessible by seller computer system 120 and buyer computer system 130 that offer one or more items for sale. For example, marketplace computer system 110 can provide a website where items won in bidding fee auctions can be listed and purchased. Marketplace computer system 110 can also provide a website to sell products that are unrelated to bidding fee auctions. For example, marketplace computer system 110 can provide a website offering books, electronics, clothing, appliances, and other consumer goods for sale that have not been listed in bidding fee auctions. Marketplace computer system 110 can also provide webpages for bidding fee auctions to seller computer system 120 and buyer computer system 130 that include links allowing users to purchase an auctioned item outside of an auction. For example, marketplace computer system 110 can provide a webpage including a bidding fee auction for a pair of headphones, and the webpage can include a link to enable users to purchase the headphones without participating in the bidding fee auction.

As described herein, seller computer system 120 can be a computer system associated with an entity that has bid on an item in a bidding fee auction, won the item, and can list the item for sale with marketplace computer system 110. Buyer computer system 130 can be a computer system associated with an entity that is interested in buying one or more items from marketplace computer system 110 that have been listed by those that have won an item in a bidding fee auction. Both seller computer system 120 and buyer computer system 130 can include a desktop computer, a laptop, a server, a mobile device (e.g., tablet, smart phone, etc.), or any other type of computing device. Seller computer system 120 and buyer computer system 130 can include one or more processors configured to execute software instructions stored in memory to perform the operations disclosed herein. For example, seller computer system 120 and buyer computer system 130 can include software that when executed by a processor performs known Internet-related communication and content presentation processes such as web browsers. In some embodiments, seller computer system 120 and buyer computer system 130 can be a mobile device that executes mobile device applications and/or mobile device communication software that allows seller computer system 120 and buyer computer system 130 to communicate with components of system 100 over network 160.

In some embodiments, marketplace computer system 110 can also communicate with advertising computer system 140. Advertising computer system 140 can include one or more computer systems that manage advertisements including banner ads, direct marketing campaigns (e.g., email campaigns, postal mail campaigns), affiliate marketing campaigns, or any other method of marketing or advertising known in the art. Advertising computer system 140 can also include one or more social media platforms that allow users to create profiles and share information and media with other users of the platform. Advertising computer system 140 can also include blog platforms and micro-blog platforms. Marketplace computer system 110 can communicate with advertising computer system 140 via an application programming interface (API) that advertising computer system 140 exposes to external computer systems. For example, advertising computer system 140 can expose an API allowing marketplace computer system 110 to provide data representing an advertisement, and when advertising computer system 140 receives the data representing the advertisement, it can post it in a micro-blog account affiliated with marketplace computer system 110.

Marketplace computer system 110 can also communicate with payment processing computer system 150. Payment processing computer system 150 can be a computer system associated with a payment processor, e.g., an entity that is appointed by a merchant to handle credit card and debit card transactions on behalf of the merchant. Payment processing computer system 150 can expose an API that accepts payment information from marketplace computer system 110. When marketplace computer system 110 receives a request to purchase an item (e.g., from buyer computer system 130) it can initiate payment by sending payment information to payment processing computer system 150.

In some embodiments, marketplace computer system 110 can include modules that perform one or more operations for selling products won in a bidding fee auction. More particularly, marketplace computer system 110 can include auction module 112, marketplace module 114, alert module 116, and redemption module 118. Although the description that follows discusses the processes and functionality of marketplace computer system 110 with respect to particular modules or combination of modules, one with skill in the art will appreciate that the described functionality can be combined into fewer modules, or the functionality described with respect to one module can be separated into additional modules according to some embodiments. Further, one or more modules described in FIG. 1 can be implemented on different computers systems that are connected to, and can be accessed by, marketplace computer system 110. For example, according to some embodiments, marketplace computer system 110 can access a computer system that performs the operations of alert module 116 or redemption module 118. In some embodiments, marketplace computer system 110 can expose an API to computer systems operating a bidding fee auction service and performing the operations of auction module 112 (e.g., as shown in FIG. 1B, below). Those with skill in the art can appreciate that the physical location of the modules described with respect to FIG. 1A does not alter the spirit and scope of the present disclosure.

In general, the word module, as used herein, refers to logic embodied in hardware or firmware, or to a collection of software instructions, possibly having entry and exit points, written in a programming language, such as, for example, C, C++, or C#, Java, or some other commonly used programming language. A software module may be compiled and linked into an executable program, installed in a library, or may be written in an interpreted programming language such as, for example, BASIC, Perl, or Python. It will be appreciated that software modules can be callable from other modules or from themselves, and/or may be invoked in response to detected events or interrupts. Software modules can be stored in any type of computer-readable medium, such as a memory device (e.g., random access, flash memory, and the like), an optical medium (e.g., a CD, DVD, BluRay, and the like), firmware (e.g., an EPROM), or any other storage medium. The software modules may be configured for execution by one or more processors in order to cause the marketplace computer system 110 to perform particular operations. It will be further appreciated that hardware modules can be comprised of connected logic units, such as gates and flip-flops, and/or can be comprised of programmable units, such as programmable gate arrays or processors. Generally, the modules described herein refer to logical modules that can be combined with other modules or divided into sub-modules despite their physical organization or storage.

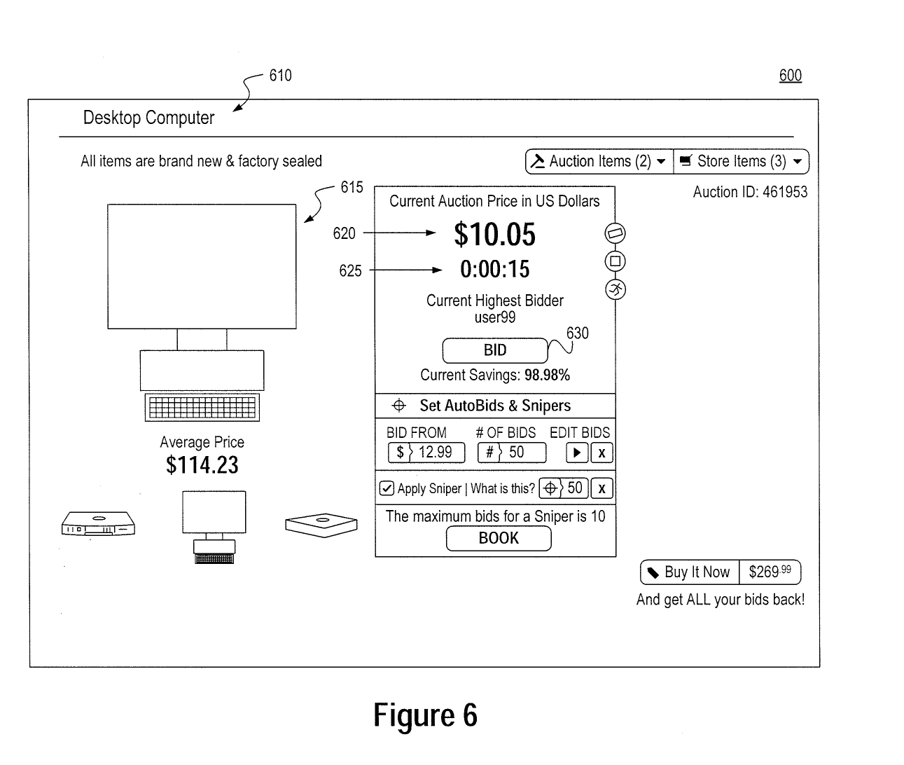

In some embodiments, marketplace computer system 110 includes auction module 112. Auction module 112 can perform operations to manage and provide bidding fee auctions to other computer systems, such as seller computer system 120 and buyer computer system 130. For example, auction module 112 can generate one or more user interfaces (e.g., the user interfaces shown in FIGS. 6-11) for viewing auctioned items, searching for auctioned items, bidding on auctioned items and claiming auctioned items. In some embodiments, auction module 112 can perform operations to initiate payment processing for a claimed auction item. For example, when a bidder wins an auction and chooses to claim the auctioned item, auction module 112 can perform operations to collect payment information from the bidder and communicate the collected payment information to payment processor computer system 150.

Auction module 112 can also perform operations to calculate the current bid value of item, debit bids from bidding users, and reset auction timers. For example, when auction module 112 provides a bidding fee auction for a vacuum, it can generate a user interface including product information associated with the vacuum, a start date and time for the auction, and a starting bid price of $0.00. When the auction begins, it can start a thirty second timer for the auction and can render a representation of the timer on the generated user interface. As bidders bid on the vacuum, auction module 112 can increase the bid price of the vacuum and reset the timer. In addition, auction module 112 can debit a bid from each bidder. For example, when userA has 50 bids and bids on the vacuum, auction module 112 can debit a bid, leaving userA with 49 bids.

Auction module 112 can, in some embodiments, offer a winning bidder an option to buy-back a won item from the winning bidder. By offering a buy-back option, the auction module 112 can advantageously provide winning bidders a way to realize profit on the auction without having to list the item for sale in an electronic marketplace. Auction module 112 can generate a user interface that provides the option to users to purchase the item. For example, when a bidder wins a bidding fee auction for a vacuum worth $250 with a right to purchase the vacuum for $50, the auction module 112 can generate a user interface providing an option to purchase the vacuum for $100, an option to claim the vacuum for $50, or list the vacuum for sale in an electronic marketplace. The auction module 112 can determine the buy-back price based on a percentage of the retail price of the item. For example, the buy-back price can be set to 50% of the retail price. In some embodiments, auction module 112 will not provide the buy-back option if the buy-back price is lower than the cost of obtaining the item. For example, when the right to purchase an item is $100 was obtained using $150 in bids, but the buy-back price is calculated as $200, auction module 112 may not offer the buy-back option to the winning bidder.

According to some embodiments, marketplace computer system 110 includes marketplace module 114. Marketplace module 114 can perform operations to manage listings for items for sale that can be accessed by other components of system 100, such as seller computer system 120 and buyer computer system 130. For example, marketplace module 114 can generate one or more user interfaces (as described below) for viewing items listed for sale, searching for items listed for sale, and purchasing items. In some embodiments, marketplace module 114 can perform operations to initiate payment processing for a purchased item. For example, when a buyer purchases an item, marketplace module 114 can perform operations to collect payment information from the buyer and communicate the collected payment information to payment processor computer system 150. Marketplace module 114 can also provide operations consistent with eCommerce systems as known in the art. For example, marketplace module 114 can provide operations supporting product reviews, shopping carts, item wish lists, recommendations, etc.

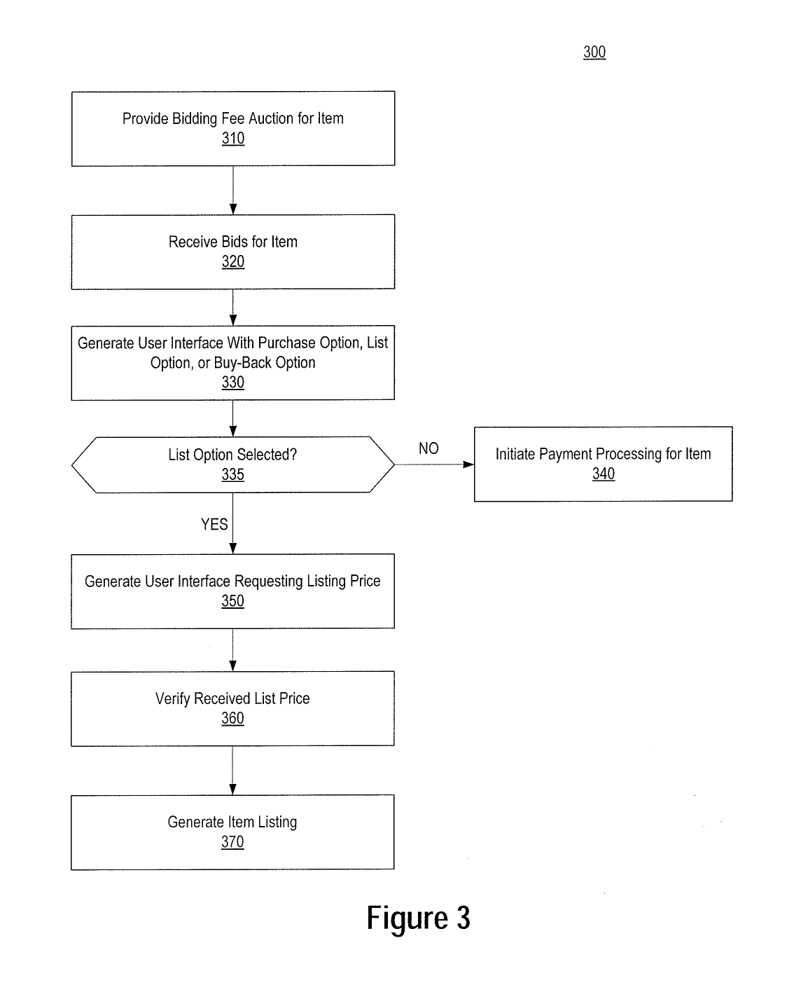

Marketplace module 114 can also perform operations for managing listings of items that have been won in bidding fee auctions. For example, marketplace module 114 can generate a user interface that provides the user of seller computer system 120 an option to list an item for sale that she won in a bidding fee auction, and marketplace computer system 110 can provide the user interface to seller computer system 120. The user interface can also request that the user of seller computer system 120 provide a list price for the item. When the list price is received, marketplace module 114 can verify that the list price complies with pricing criteria, as described below with respect to FIG. 3. In some embodiments, marketplace module 114 can offer a buy-back option as described above with respect to auction module 112.

In some embodiments, marketplace module 114 maintains an edit lock on items listed for sale. Marketplace module 114 can use edit locks to prevent issues that might arise when seller computer system 120 is attempting to edit a listed item and buyer computer system 130 is attempting to purchase the same item at the same time. Marketplace module 114 can also use edit locks to ensure consistent marketing and advertising efforts by making sure that visitors to the website marketplace module 114 provides see listings consistent with advertisements. An edit lock can be applied to the item when certain edit restrictions apply. Edit restrictions can include, among others, a first edit restriction, an edit count restriction, a last edit restriction, and an edit frequency restriction. A first edit restriction can restrict an item from being edited for a specific period of time (e.g., 24 hours) after it is made available for sale by marketplace computer system 110 for the first time. An edit count restriction can limit the number of times seller computer system 120 can edit an item listed for sale. A last edit restriction can restrict an item from being edited for a specific period of time after it was last edited (e.g., 10 hours). An edit frequency restriction can limit the number of times seller computer system 120 can edit an item listed for sale within a specific period of time (e.g., 3 times a week). In some embodiments, marketplace module 114 can apply an edit lock to an item when buyer computer system 130 has requested that the item be reserved for purchase (e.g., placed in an online shopping cart).

Marketplace module 114 can also place restrictions on the purchase of items listed for sale. As one item can be available for different prices, and since inventory needs to be controlled, when a first buyer places an item listed at a particular price in her shopping cart, the item can be made unavailable to other buyers. However, buyers can abuse such a system by placing items in their carts indefinitely thereby preventing other buyers from purchasing the items. In some embodiments, marketplace module 114 can implement reserve restrictions to combat this abuse. A reserve restriction can limit how long an item can be reserved for purchase, or remain in the shopping cart of a buyer. For example, marketplace module 114 can allow an item to be saved in a shopping cart for five minutes, and when the five minutes is over, the item can be made available again for purchase. In some embodiments, marketplace module 114 can generate a user interface that includes a countdown timer informing buyers of how much longer a particular item can remain in their shopping carts. Marketplace module 114 can also place other restrictions on buying such as limits on the number of items in a shopping cart at one time (e.g. no more than 5 items at one time), or the number of items that can be purchased by a single buyer for a time period (e.g., no more than 10 items per week).

In some embodiments, marketplace module 114 can provide an option to purchase a listed item from a seller if it does not sell within a particular time period. For example, marketplace module 114 can offer to purchase a listed item from a seller for 50% of its list price or retail price, if the seller has not sold the item after it has been listed in the electronic marketplace for thirty days.

According to some embodiments, marketplace computer system 110 includes alert module 116. Alert module 116 can perform operations to alert components of system 100, such as seller computer system 120 and buyer computer system 130 of important events. For example, when a user of buyer computer system 130 misses the opportunity to purchase an item through marketplace computer system 110, buyer computer system 130 can request that it be sent an alert when the same, or similar, item is listed in the future. In addition, buyer computer system 130 can request that a watch be placed on a non-purchased but reserved item so that if the item becomes available, marketplace computer system 110 can notify buyer computer system 130. Alert module 116 can also alert seller computer system 120 when an item won in a bidding fee auction and listed for sale in the marketplace has been purchased, or when an item listed for sale has not been purchased after a certain period of time (e.g, 30 days).

Alert module 116 can generate alerts that can be included in a user interface generated by one or more of the other modules of marketplace computer system 110. For example, alert module 116 can generate an alert that can be displayed as a pop-up window in a user interface generated by marketplace module 114. In some embodiments, alert module 116 can send a message to one of the other modules of marketplace computer system 110 alerting the other modules of the alert condition, and the other module(s) can generate a user interface with the alert information. For example, when buyer computer system 130 places a watch on a reserved item, and the reserved item becomes unreserved, alert module 116 can send a message to marketplace module 114 to generate a user interface and provide it to buyer computer system 130.

In some embodiments, alert module 116 can generate electronic communications that can be sent to one or more components of system 100 such as an email, short-message service message, multimedia message service message, or text message when an alert has been triggered. For example, buyer computer system 130 can create an alert for a reserved item. When creating alert, buyer computer system 130 can provide an email address, and when the item becomes unreserved, alert module 116 can generate an email and send it to the provided email address. In some embodiments, alert module 116 can generate a message that can be consumed by a client side application executing on one of the components of system 100 such as seller computer system 120 or buyer computer system 130. For example, seller computer system 120 can be a mobile device executing a client side application that interfaces with marketplace computer system 110. When an item that the user of seller computer system 120 listed has sold, alert module 116 can send a message to the client application and the client application can display the alert for the user.

In some embodiments, marketplace computer system includes redemption module 118. Redemption module 118 can be configured to perform operations for determining a redemption value awarded to sellers (e.g., users of seller computer system 120) that have listed and sold an item with marketplace computer system 110. Redemption module 118 can provide redemption in the form of money (e.g., a check or cash), store credit that can be applied to the future purchase of an item from marketplace computer system 110, credit card account credit, and/or bids that can be used in bidding fee auctions managed by auction module 112. In some embodiments, redemption module 118 receives a communication indicating a redemption value preference and awards the redemption value according to the preference. For example, after an item is sold, a communication can be sent to seller computer system 120 requesting a redemption value preference of cash, store credit, credit card account credit, or bids. Once a user selects a redemption value preference, redemption module 118 can receive the selected preference and award the redemption value accordingly. For example, when the selected preference is bids, redemption module 118 can award bids to an account associated with the user operating seller computer system 120.

Redemption module 118 can also determine the redemption value based on the final bid price of an item, the list price of the item, and a transaction fee. For example, redemption module 118 can calculate the redemption value by subtracting the final bid price of the item and the transaction fee from the list price of the item. For example, when the final bid price of an item is $100, the list price of the item is $500, and the transaction fee is 5% of the list price, redemption module 118 can calculate the redemption value as $375 ($500 list price−$100 final bid price−$25 transaction fee). When the redemption preference is non-cash, redemption module 118 can award the cash equivalent of the redemption value. For example, when the redemption value is $375, redemption module 118 can award $375 worth of store credit or bids.

As noted above, the modules of marketplace computer system 110 can be capable of generating user interfaces that can be provided to other components of system 100 including, for example, seller computer system 120 and buyer computer system 130. The modules can, for example, generate HTML code, or scripts capable of generating HTML code, that can be displayed in a web browser executing on a computing device (e.g., seller computer system 120 or buyer computer system 130). For example, the modules can generate user interfaces using jQuery, JavaScript, PHP, ASP, or some other known language for generating dynamic user interfaces. In some embodiments, the modules can provide user interface objects to a client application executing on a computing device (e.g., seller computer system 120 or buyer computer system 130), or they can provide data that is capable of being displayed in a user interface in a client application executing on a computing device. In some embodiments, the modules can generate user interfaces that can be displayed within another user interface. For example, the modules can generate a user interface for display within a parent user interface that is part of a word processing application, a presentation development application, a web browser, or an illustration application, among others. As used herein, the term “generating” in reference to a user interface can include generating code that when executed displays information (e.g., HTML) or providing commands and/or data to a set of instructions that when executed render a user interface capable of being shown on a display connected to a computing device. Examples of some (although not all) user interfaces that the modules of marketplace computer system can generate are described below with respect to FIGS. 6-11.

Although the embodiment of marketplace computer system 110 illustrated in FIG. 1A includes auction module 112 and provides bidding fee auctions, marketplace computer system 110 can also perform operations for accepting listings for items won in auctions that it did not provide. FIG. 1B illustrates one embodiment of system 100 where marketplace computer system 110 communicates with auction computer system 180. Auction computer system 180 can be a computer system that offers auctions to one or more users. In some embodiments, marketplace computer system 110 can expose an API that allows auction computer system 180 to provide item listing information. When a user (e.g., operating seller computer system 120) wins an auction, auction computer system 180 can communicate with marketplace computer system 110 to provide the computer system of the user that won the auction an option to list the item with marketplace computer system 110. When the user chooses the option to list the item, auction computer system 180 can collect information regarding the listing from the computer system of the user and provide it to marketplace computer system 110. In some embodiments, auction computer system 180 can also collect information regarding the user, such as personal information (e.g., name, address, telephone number, email, etc.) or transactional information (e.g., payment or bank account information) and provide it to marketplace computer system 110. Auction computer system 180 can also redirect the computer system of the user to marketplace computer system 110 to list the item. According to some embodiments, auction computer system 180 can perform one or more operations described above with respect to auction module 112.

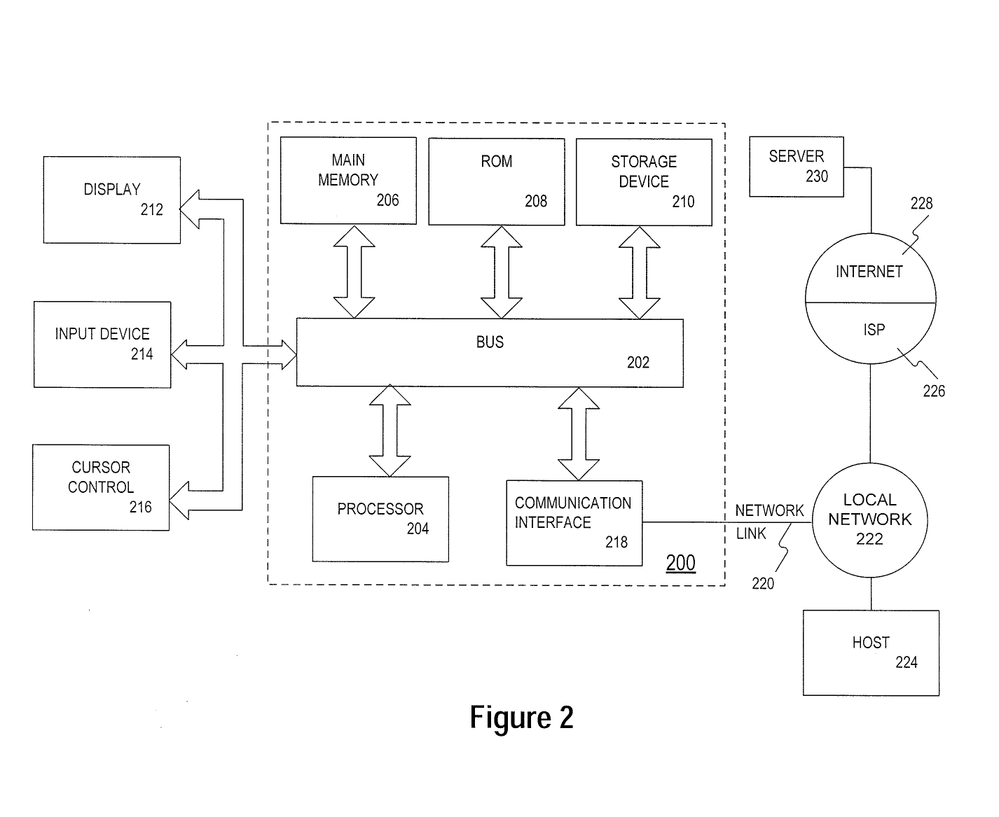

FIG. 2 is a block diagram of an exemplary computer system 200, consistent with embodiments of the present disclosure. The components of system 100, such as marketplace computer system 110, seller computer system 120, buyer computer system 130, advertising computer system 140, and payment processing computer system 150 may include an architecture based on, or similar to, that of computer system 200.

As illustrated in FIG. 2, computer system 200 includes a bus 202 or other communication mechanism for communicating information, and hardware processor 204 coupled with bus 202 for processing information. Hardware processor 204 can be, for example, a general purpose microprocessor. Computer system 200 also includes a main memory 206, such as a random access memory (RAM) or other dynamic storage device, coupled to bus 202 for storing information and instructions to be executed by processor 204. Main memory 206 also can be used for storing temporary variables or other intermediate information during execution of instructions to be executed by processor 204. Such instructions, when stored in non-transitory storage media accessible to processor 204, render computer system 200 into a special-purpose machine that is customized to perform the operations specified in the instructions. Computer system 200 further includes a read only memory (ROM) 208 or other static storage device coupled to bus 202 for storing static information and instructions for processor 204. According to some embodiments, a storage device 210, such as a magnetic disk or optical disk, is provided and coupled to bus 202 for storing information and instructions.

In some embodiments, computer system 200 can be coupled via bus 202 to display 212, such as a cathode ray tube (CRT), liquid crystal display, or touch screen, for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. The input device typically has two degrees of freedom in two axes, a first axis (for example, x) and a second axis (for example, y), that allows the device to specify positions in a plane.

Computer system 200 can implement disclosed embodiments using customized hard-wired logic, one or more ASICs or FPGAs, firmware and/or program logic which in combination with the computer system causes or programs computer system 200 to be a special-purpose machine. According to some embodiments, the operations, functionalities, and techniques disclosed herein are performed by computer system 200 in response to processor 204 executing one or more sequences of one or more instructions contained in main memory 206. Such instructions can be read into main memory 206 from another storage medium, such as storage device 210. Execution of the sequences of instructions contained in main memory 206 causes processor 204 to perform process steps consistent with disclosed embodiments. In some embodiments, hard-wired circuitry can be used in place of or in combination with software instructions.

The term “storage media” as used herein refers to any non-transitory media that stores data and/or instructions that cause a machine to operate in a specific fashion. Such storage media can comprise non-volatile media and/or volatile media. Non-volatile media includes, for example, optical or magnetic disks, such as storage device 210. Volatile media includes dynamic memory, such as main memory 206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from, but can be used in conjunction with, transmission media. Transmission media participates in transferring information between storage media. For example, transmission media includes coaxial cables, copper wire and fiber optics, including the wires that comprise bus 202. Transmission media can also take the form of acoustic or light waves, such as those generated during radio-wave and infra-red data communications.

Various forms of media can be involved in carrying one or more sequences of one or more instructions to processor 204 for execution. For example, the instructions can initially be carried on a magnetic disk or solid state drive of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 can optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 can be an integrated services digital network (ISDN) card, cable modem, satellite modem, or a modem to provide a data communication connection. As another example, communication interface 218 can be a local area network (LAN) card to provide a data communication connection to a compatible LAN. Wireless links can also be implemented. In any such implementation, communication interface 218 sends and receives electrical, electromagnetic or optical signals that carry digital data streams representing various types of information.

Network link 220 typically provides data communication through one or more networks to other data devices. For example, network link 220 can provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are example forms of transmission media.

Computer system 200 can send messages and receive data, including program code, through the network(s), network link 220 and communication interface 218. In the Internet example, a server 230 can transmit a requested code for an application program through Internet 228, ISP 226, local network 222 and communication interface 218. The received code can be executed by processor 204 as it is received, and/or stored in storage device 210, or other non-volatile storage for later execution.

### Description of Example Processes

As described above with respect to FIGS. 1A and 1B, marketplace computer system 110 can perform one or more processes for offering products for sale using auctions or a marketplace. FIGS. 3-5 include flowcharts illustrating exemplary processes for offering products for sale consistent with embodiments of the present disclosure. While FIGS. 3-5 illustrate processes using particular methodologies or techniques, other methodologies or techniques known in the art can be substituted without detracting from the spirit and scope of disclosed embodiments. Also, while the description that follows describes the processes of FIGS. 3-5 as performed by marketplace computer system 110 and its associated modules, in some embodiments, another component of system 100, or some sub-system of the components of system 100 (not shown) can perform part or all of these processes. In addition, while the flowcharts of FIGS. 3-5 disclose process steps in a particular order, it will be appreciated that at least some of the steps can be moved, modified, or deleted where appropriate.

FIG. 3 shows a flowchart representing an exemplary process 300 for listing an item won in a bidding fee auction. Marketplace computer system 110 begins process 300 by providing a bidding fee auction for an item (step 310). Marketplace computer system 110 can generate a user interface including a description of the item (including, for example, text, images, and comments about the item), a current bid price, and one or more user interface elements for facilitating bidding on the item (e.g., buttons). Marketplace computer system 110 can provide the bidding fee auction in a webpage that it serves to other computers such as seller computer system 120. One example of a user interface providing a bidding fee auction for an item is shown in FIG. 6 and is described below.

After providing the bidding fee auction for the item, marketplace computer system 110 can receive one or more bids for the item (step 320). Marketplace computer system 110 can receive bids for an item after a bidder (e.g., user of seller computer system 120) selects a user interface element corresponding to placing a bid, and the user interface element communicates to marketplace computer system 110 that it has been selected. For example, a user operating seller computer system 120 can place her mouse over a button labeled “BID.” When the user selects the button (e.g., by clicking the mouse), the user interface containing the button can generate an event message indicating that the button was selected, and the event message can be communicated to marketplace computer system 110. When marketplace computer system 110 receives the event message, it can increase the bid price of the item by the bid amount (e.g, increasing the bid price by $0.01), and debit the bid from the bidder's account. Marketplace computer system 110 can also reset the timer for the bidding fee auction. Marketplace computer system 110 can receive more bids as the bidding fee auction continues. At the conclusion of the bidding fee auction, marketplace computer system 110 can determine a winning bidder.

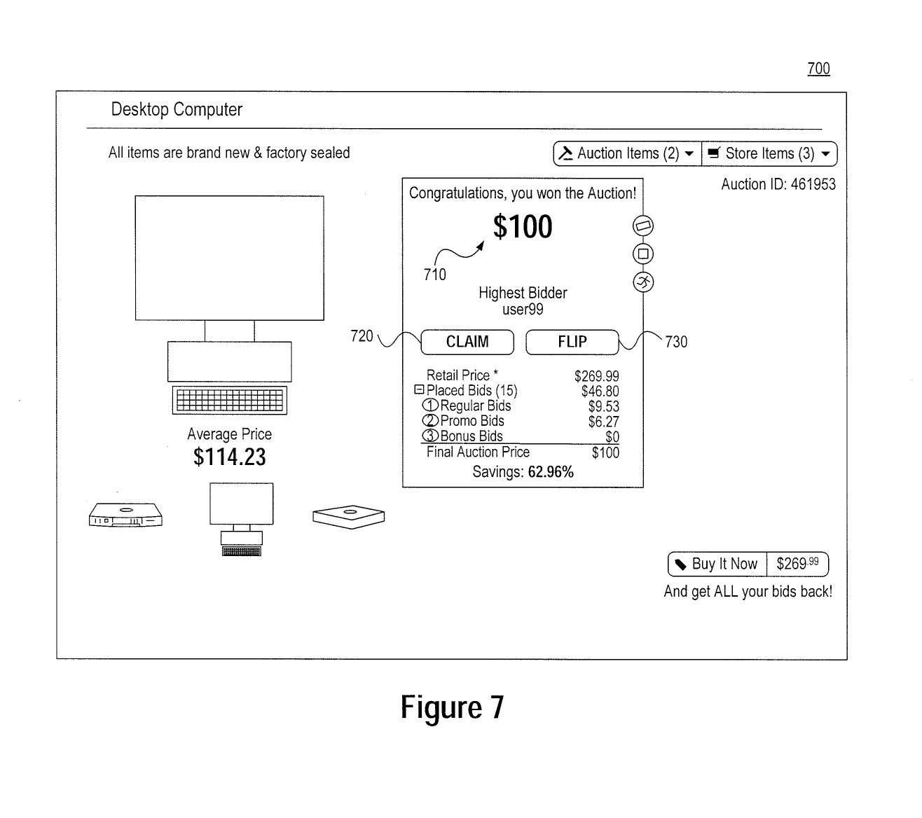

After determining a winning bidder, marketplace computer system can generate a user interface with an option to purchase the item at the winning bid price, an option to list the item for sale on the marketplace, or an option to buy-back the item from the winning bidder (step 330). The generated user interface can include selection user interface elements capable of capturing a user selection. For example, the user interface elements can be a group of radio buttons, group of selection buttons, or a selection list. Once marketplace computer system 110 generates the user interface, marketplace computer system 110 can communicate the user interface to a computer system operated by the winning bidder (e.g., seller computer system 120), and the computer system operated by the winning bidder can display the user interface. When the winning bidder selects either the purchase option, the list option, or the buy-back option, the selection user interface elements can detect the selections and generate an event message indicating the selection. The computer system of the winning bidder can communicate the event message to marketplace computer system 110, which can analyze the event message to determine the selected option. One example of a user interface including a purchase option and a list option is illustrated in FIG. 7 and described below.

When marketplace computer system 110 determines that the purchase option or the buy-back option was selected (step 335: NO), it can initiate payment processing for the item (step 340). For example, marketplace computer system 110 can request the computer system of the winning bidder provide payment information (e.g., credit card data) for the item, or account information to provide a credit (e.g., checking account information). Once marketplace computer system 110 receives the payment information, it can initiate payment processing for the item by sending the payment information to payment processor computer system 150. Marketplace computer system 110 can then receive payment confirmation and initiate delivery of the item to the winning bidder.

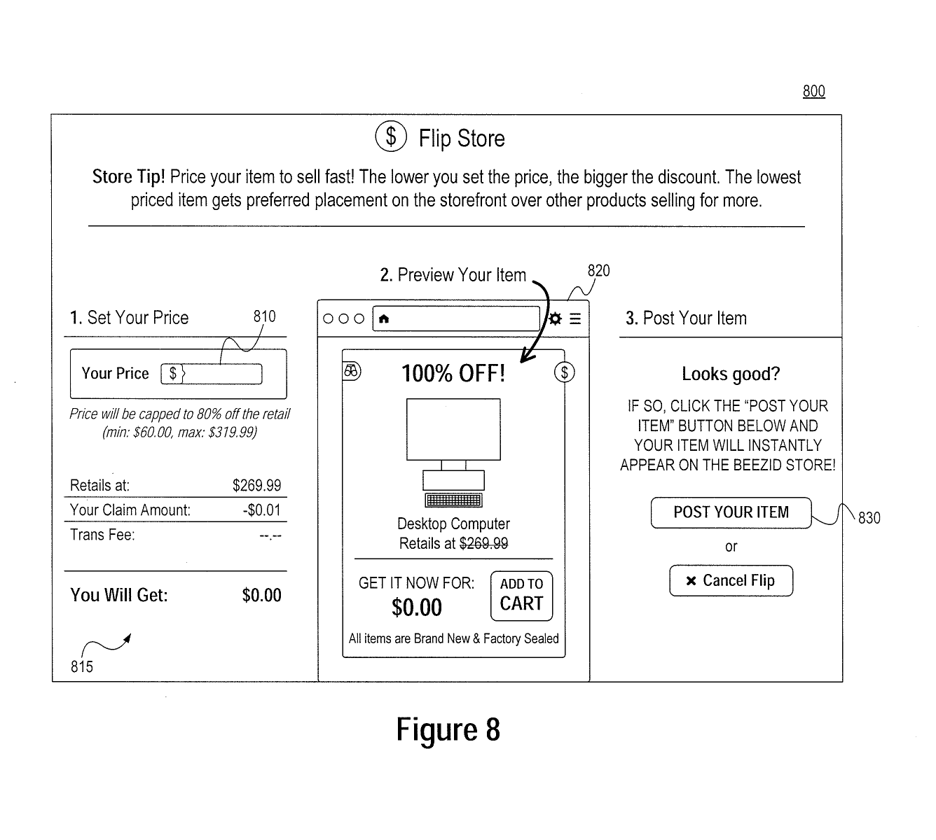

When marketplace computer system 110 determines that the list option was selected (step 335: YES), it can generate a user interface requesting the listing price (step 350). For example, marketplace computer system 110 can generate a user interface including a text field that can accept as input text indicating a price for selling the item. Marketplace computer system 110 can send the user interface to the computer system of the seller (e.g., seller computer system 120), and the seller can provide a list price. The user interface can also include a selectable user interface element that when selected, sends the list price to marketplace computer system 120. One example of a generated user interface requesting a list price is illustrated in FIG. 8 and described below.

After marketplace computer system 110 receives the list price from the seller's computer system, it can verify the received list price (step 360). In some embodiments, marketplace computer system 110 analyzes provided list prices with respect to pricing criteria. The pricing criteria can specify a minimum list price and a maximum list price for an item. Marketplace computer system 110 can use the minimum list price to ensure that the seller will not owe money to the operator of marketplace computer system 110 when the item sells. Marketplace computer system 110 can determine the minimum list price as the final bid price plus any transaction fees associated with listing the item on the marketplace. For example, when the final bid price of an item is $50, the transaction fees for listing the item are 10% of the list price, and the list price entered by the seller is $200, marketplace computer system 110 can determine that minimum price of the item is $70. Since $200 is more than the minimum price, the list price received by marketplace computer system 110 satisfies the minimum price criterion. In some embodiments, marketplace computer system 110 can determine the maximum list price based on a percentage of the retail price of the item. For example, if the retail price of an item is $1000 and the percentage of the retail price defining the maximum list price is 80%, then marketplace computer system 110 can determine that the maximum list price for the item is $800. Accordingly, when marketplace computer system 110 receives a list price that is lower than $800, the list price will satisfy the maximum list price criterion.

In some embodiments, marketplace computer system 110 can calculate pricing criteria differently for different items, for example, marketplace computer system 110 can calculate first pricing criteria for a first item and second pricing criteria for a second item. Pricing criteria can be based on the category of item (e.g., computers, appliances, electronics, clothing), the manufacture of the item, the price of the item, or the specific item. For example, marketplace computer system 110 can determine the maximum list price for computers as 75% of retail value, the minimum list price for products made by Sony as 65% of retail value, the maximum list price for products with a retail value under $10 as $6, or that a television with stock keeping unit number 123456789 has a minimum list price of $1000 and a maximum list price of $1500.

As part of verifying the received list price, marketplace computer system 110 can inform sellers if the item they are listing with the marketplace is available from other sellers for less. For example, a first seller might set the list price of an item at $800. A second seller can request a list price of $900 for the same item. When marketplace computer system 110 receives the second seller's list price request, it can generate a message and send it to the computer system of the second seller informing the second seller that the same item is available on the marketplace for $800. Marketplace computer system 110 can also generate a user interface to send to the computer system of the second seller providing the second seller with an opportunity to modify the list price, or purchase the item instead.

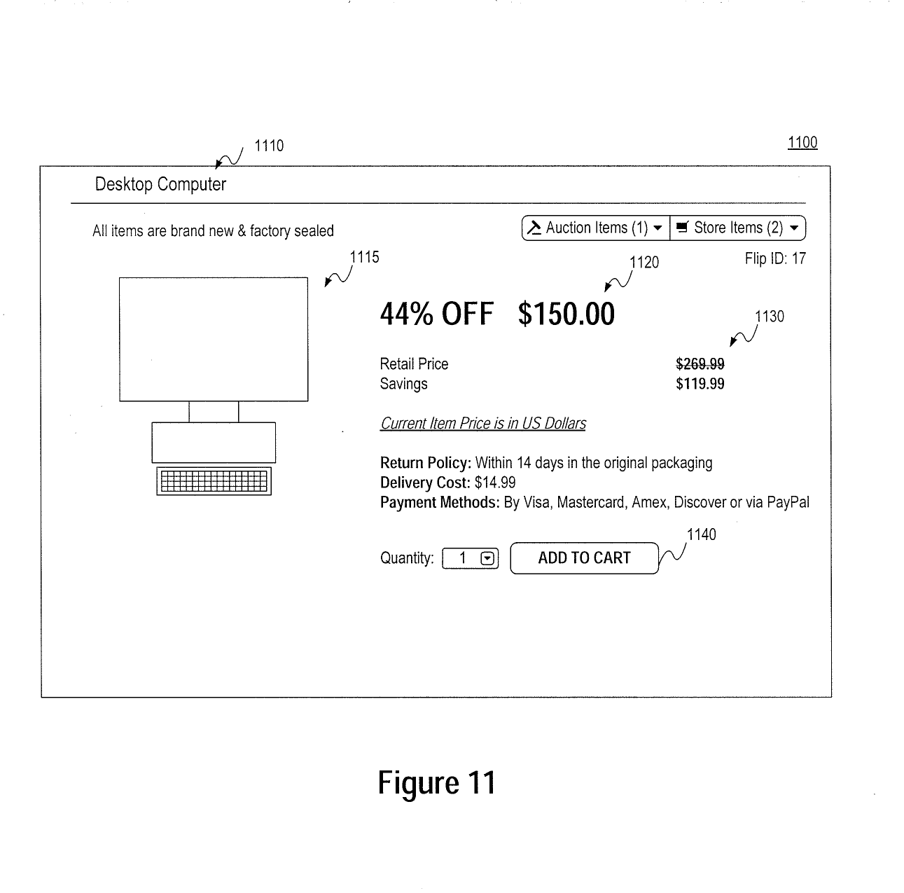

Once marketplace computer system 110 verifies the received list price, it can generate a listing for the item (step 370). Marketplace computer system 110 can generate the listing by generating a user interface including a description of the item and one or more user interface elements that can be used to initiate purchase of the item. The listing can appear on the website of the marketplace computer system 110 and can be available to potential buyers (e.g., a user operating buyer computer system 130). One example of a user interface including an item listing is illustrated in FIG. 11 and described below.

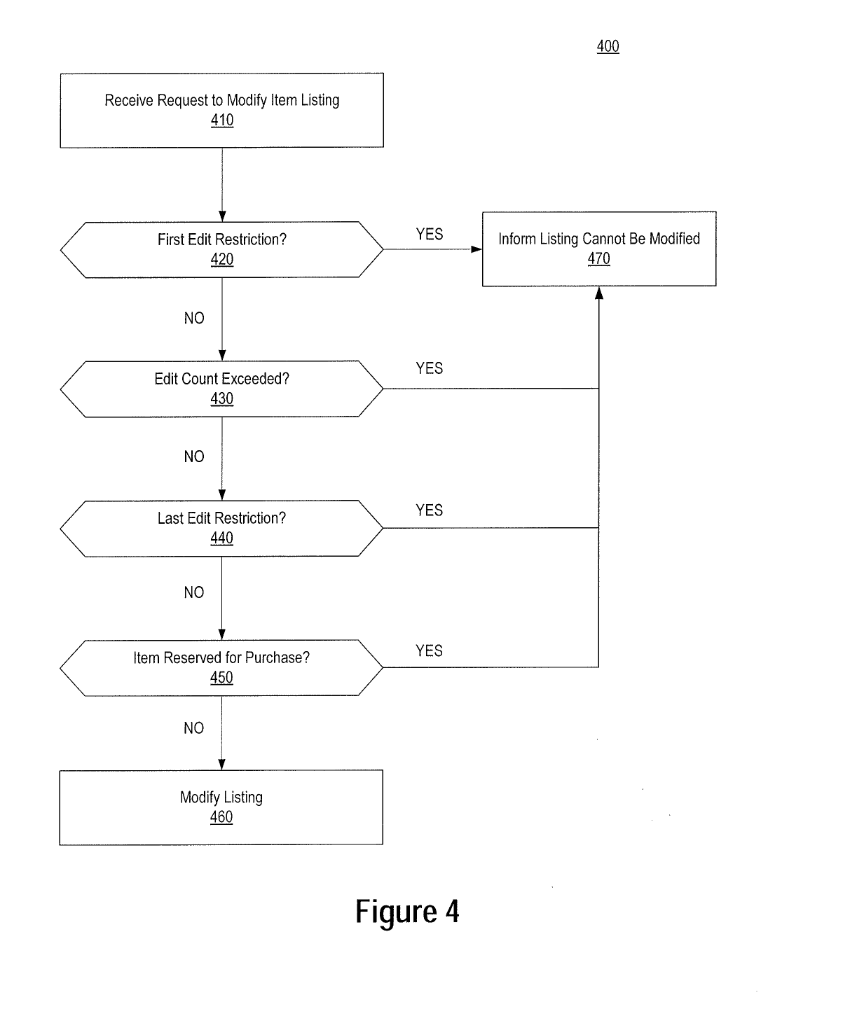

As described above, marketplace computer system 110 can place one or more edit locks on an item listing that prevents the item from being modified. FIG. 4 shows a flowchart representation of an exemplary process 400 for modifying an item listing, consistent with the embodiments of the present disclosure. Although process 400 shows four examples of edit locks: first edit restriction, an edit count restriction, a last edit restriction, and a reserved product restriction, other edit locks are contemplated. Marketplace computer system 110 begins process 400 by receiving a request to modify a product listing (step 410). Marketplace computer system 110 determines if the first edit restriction applies to the item (step 420). If there is a first edit restriction on the item, marketplace computer system 110 can generate a message to send to the computer system of the seller of the item (e.g, seller computer system 120) informing the seller that the listing cannot be modified (step 470). Next, marketplace computer system 110 determines whether the edit count for the listing has been exceeded (step 430), and if so, marketplace computer system 110 generates a message to send to the computer system of the seller of the item (e.g, seller computer system 120) informing the seller that the listing cannot be modified (step 470). Next, marketplace computer system 110 determines whether there is a last edit restriction for the listing (step 440), and if so, marketplace computer system 110 generates a message to send to the computer system of the seller of the item (e.g, seller computer system 120) informing the seller that the listing cannot be modified (step 470). Finally, marketplace computer system 110 determines if the item in the listing is reserved for purchase (step 450). If the item is reserved, the listing cannot be modified and marketplace computer system 110 generates a message to send to the computer system of the seller of the item (e.g, seller computer system 120) informing the seller that the listing cannot be modified (step 470). When marketplace computer system 110 determines there is no edit lock on the listing, it will modify the listing according to the received request (step 460).

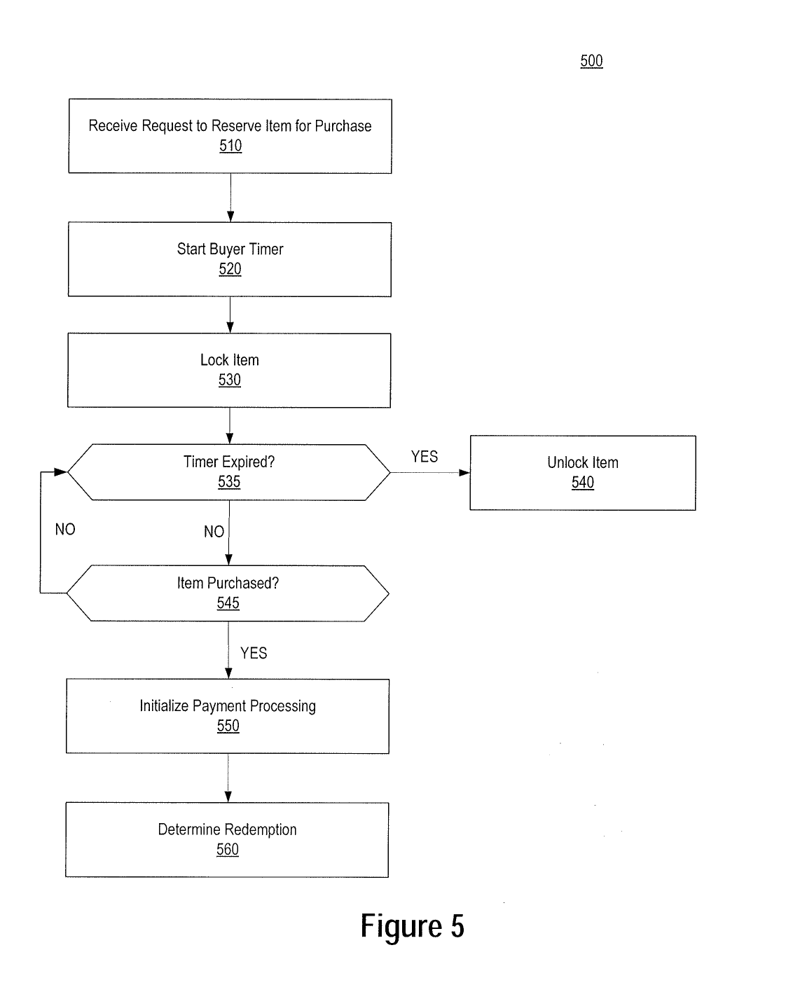

FIG. 5 shows a flowchart representation an exemplary process 500 for purchasing a product, consistent with the embodiments of the present disclosure. Marketplace computer system 110 begins process 500 by receiving a request to reserve an item for purchase (step 510). Marketplace computer system 110 can receive the request from buyer computer system 130 when a buyer operating buyer computer system 130 places the item in her shopping cart, for example. When marketplace computer system 110 receives the request to reserve an item for purchase, it can start a buyer timer (step 520) and lock the item from editing by the seller of the item or from purchase by other buyers (step 530). As described above with respect to FIG. 1A, as items are locked from editing or from purchasing by other buyers, when a buyer reserves the item for purchase, marketplace computer system 110 can place a restriction on the amount of time a product can be reserved. For example, marketplace computer system 110 can limit a reservation to five minutes. If the item is not purchased within the length of time of the buyer timer (step 535: YES, step 545: NO), marketplace computer system 110 will unlock the item (step 540). If the item is purchased (step 545: YES), marketplace computer system 110 can initialize payment processing for the item (step 550). Once payment has been processed and confirmed, marketplace computer system 110 can determine the redemption to award the seller (step 560). Marketplace computer system 110 can use, for example, the operations described above with respect to redemption module 118 to determine the redemption value.

### Description of Example User Interfaces

FIGS. 6-11 illustrate several exemplary user interfaces that can be generated by marketplace computer system 110, consistent with embodiments of the present disclosure. For example, the user interfaces described in FIGS. 6-11 can be generated by auction module 112 and/or marketplace module 114. The exemplary user interfaces of FIGS. 6-11 are meant to help illustrate and describe certain features of disclosed embodiments, and are not meant to limit the scope of the user interfaces that can be generated or provided by marketplace computer system 110.

FIG. 6 shows a screenshot of an exemplary depiction of a graphical user interface 600 illustrating one example of a bidding fee auction user interface that marketplace computer system 110 can generate. Graphical user interface 600 can include description 610 that describes the item available in the bidding fee auction, and image 615 showing an image of the item available in the bidding fee auction. Graphical user interface 600 can also include bid price label 620 that provides an indication of the current bid price of the item, and auction timer 625. Bid button 630 can be a selectable user interface element that, when selected by a user, communicates a message to marketplace computer system 110 that a bid has been placed. Marketplace computer system 110 can process the bid and update bid price label 620 and auction timer 625. For example, if marketplace computer system 110 receives a bid, it can update bid price label 620 to $10.06 and reset auction timer 625 to 0:00:20.

FIG. 7 shows a screenshot of an exemplary depiction of a graphical user interface 700 that marketplace computer system 110 can generate when a bidder wins a bidding fee auction. Graphical user interface 700 can include final bid price label 710 showing the final bid price for the item. Graphical user interface 700 can also include purchase option button 720 and list option button 730. When a winning bidder selects purchase option button 720, marketplace computer system 110 receives a message indicating that item will be purchased by the winning bidder, and marketplace computer system 110 can initiate payment processing. When a winning bidder selects list option button 730, marketplace computer system 110 can perform one or more operations to generate a listing for the item consistent with the embodiments disclosed herein. For example, marketplace computer system 110 can generate a user interface requesting that the winning bidder provide a list price for the item.

FIG. 8 shows a screenshot of an exemplary depiction of graphical user interface 800. Marketplace computer system 110 can generate graphical user interface 800 to request a listing price for an item and confirm the listing for the item. Graphical user interface 800 can include list price text field 810. The winning bidder can use list price text field 810 to enter a list price for the item. In some embodiments, when graphical user interface 800 detects input in list price text field 810, it can generate an estimate of the redemption value the winning bidder can receive when the item is purchased. Graphical user interface 800 can display the estimated redemption value in user interface element 815. Also, graphical user interface 800 can provide a preview of the listing in preview panel 820. After the winning bidder enters the listing price, she can post the item by clicking on post listing button 830. When post listing button 830 is selected, marketplace computer system 110 can receive a message that the listing for the item is complete, and marketplace computer system 110 can verify the list price as described above.

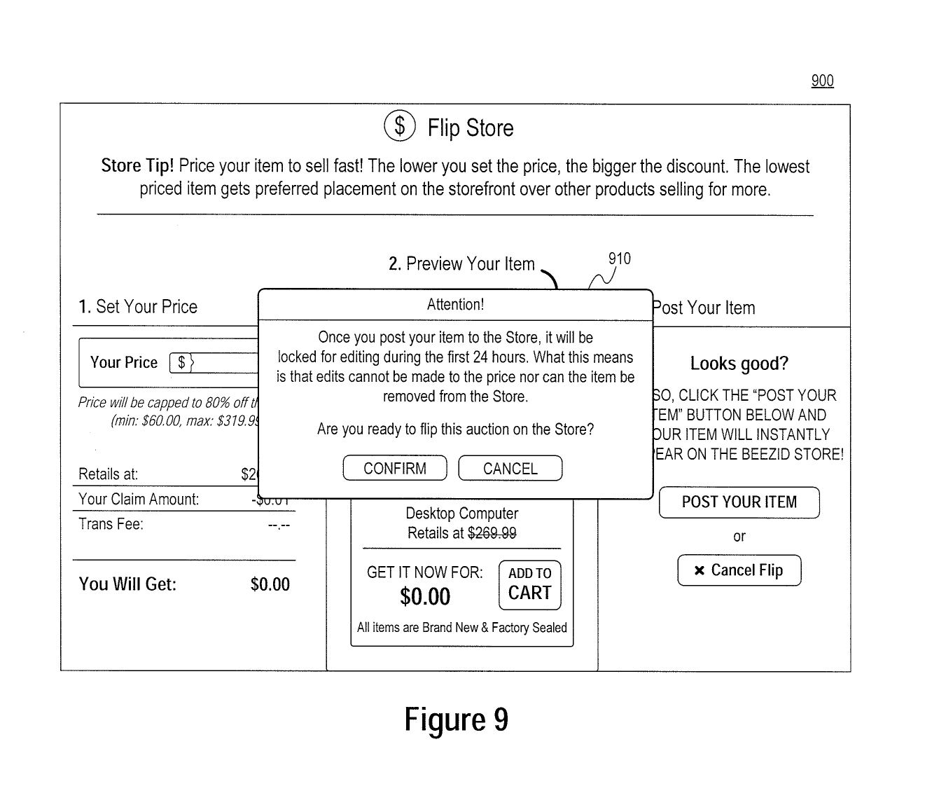

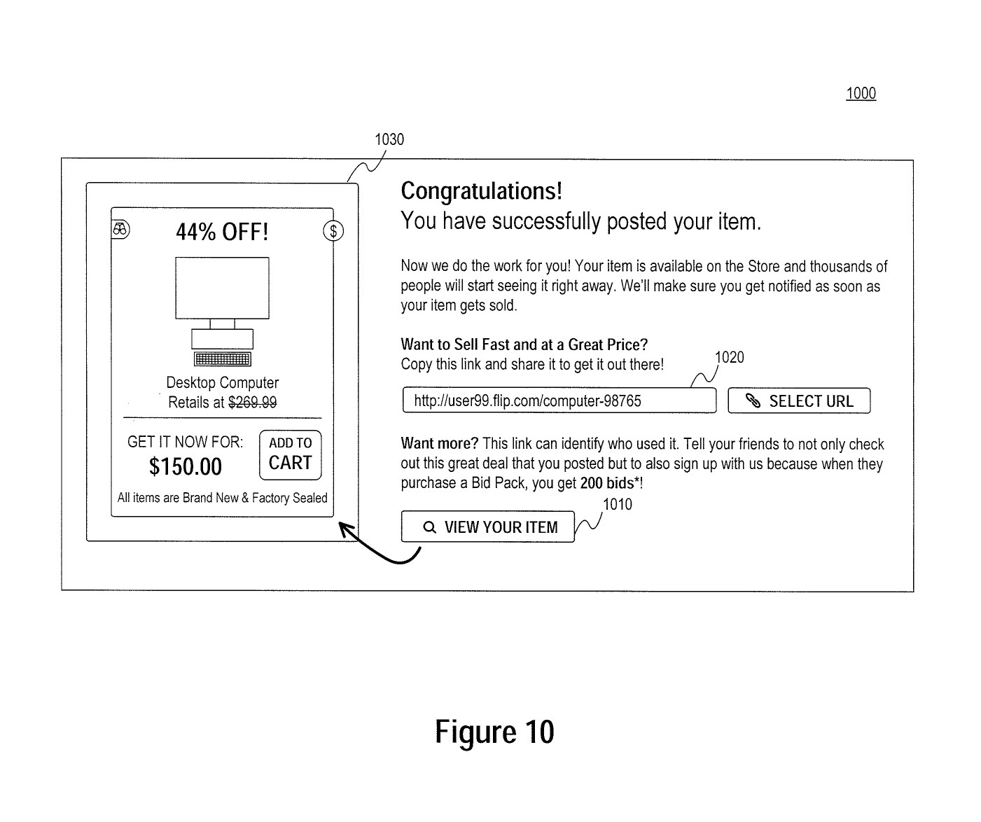

As shown in FIG. 9, marketplace computer system can generate graphic user interface 900 requesting confirmation of the listing. Graphic user interface 900 can include dialog 910 requesting confirmation of the listing and reminding the winning bidder of the edit lock that is applied to the listing as a result of the first edit restriction. Once confirmed, marketplace computer system 110 can generate graphical user interface 1000, as shown in FIG. 10. Graphical user interface 1000 can provide button 1010 that when selected generates a quick preview 1030 of the listing. Graphical user interface 1000 can also include a link 1020 that the winning bidder can share on social media platforms or in email.

FIG. 11 shows graphical user interface 1100, which is an example of a listing that marketplace computer system 110 can generate. Graphical user interface 1100 can include description label 1110 that provides a description of the item for sale and image 1115 showing an image of the item for sale. In some embodiments, graphical user interface 1100 can include an icon (not shown) that indicates the listing is for a flipped item. Graphical user interface 1100 can also include listing price label 1120 showing the listing price for the item and savings label 1130 that communicates the savings that buyers can realize through purchasing the item through the marketplace. When a buyer would like to add the item to her shopping cart, she can, for example, select cart button 1140, or use some other method of adding an item to her shopping cart. When selected, marketplace computer system 110 can receive a message requesting that the item be added to the buyer's shopping cart, thereby reserving the item for purchase. In some embodiments, after marketplace computer system 110 receives the message, it can perform the operations of process 500 (as shown in FIG. 5) to handle the purchase of the item.

In the foregoing specification, embodiments have been described with reference to numerous specific details that can vary from implementation to implementation. Certain adaptations and modifications of the embodiments described herein can be made. Therefore, the above embodiments are considered to be illustrative and not restrictive.

What is claimed is:

1. A method for selling items won in a bidding fee auction, the method being performed by one or more processors of one or more computers and comprising:
providing a bidding fee auction for an item;
receiving one or more bids for the item;
determining a winning bidder based on the received one or more bids;
generating a user interface including:
a first option to purchase the item at a purchase price calculated based on the one or more bids, and
a second option to list the item for sale in an electronic marketplace;
receiving a selection including the first option or the second option;
initiating payment processing for the item when the selection includes the first option;
generating a user interface requesting a listing price for the item when the selection includes the second option;
receiving the listing price in response to generating the user interface requesting the listing price;
verifying the received listing price; and
generating, based on the verification of the listing price, a listing including a description of the item and the listing price.

2. The method of claim 1 further including receiving a request to purchase the item at the listing price.

3. The method of claim 2 further including initiating payment processing for the item based on the listing price.

4. The method of claim 1 further including determining a redemption value to provide the winning bidder as a result of the sale of the item.

5. The method of claim 4 wherein the redemption value includes a plurality of bids that can be used in bidding fee auctions.

6. The method of claim 1 further including providing an option to edit the listing.

7. The method of claim 6 wherein the option to edit the listing is not provided for a period of time after the listing has been generated.

8. The method of claim 7 wherein the option to edit the listing is not provided when the item has been reserved for purchase.

9. A system for selling items won in a bidding fee auction, the system comprising:
a memory device storing a set of instructions,
one or more processors configured to execute the set of instructions that cause the one or more processors to:
provide a bidding fee auction for a item;
receive a one or more bids for the item;
determine a winning bidder based on the received one or more bids;
generate a user interface providing the winning bidder:
a first option to purchase the item at a purchase price calculated based on the one or more bids, and
a second option to list the item for sale in an electronic marketplace;
receive a selection including the first option or the second option;
initiate payment processing for the item when the selection includes the first option;
generate a user interface requesting a listing price for the item when the selection includes the second option;
receive the listing price in response to generating the user interface requesting the listing price;
verify the received listing price; and
generate, based on the verification of the listing price, a listing including a description of the item and the listing price.

10. The system of claim 9 wherein the one or more processors are further configured to include receiving a request to purchase the item at the listing price.

11. The system of claim 10 wherein the one or more processors are further configured to initiate payment processing for the item based on the listing price.

12. The system of claim 9 wherein the one or more processors are further configured to determine a redemption value to provide the winning bidder as a result of the sale of the item.

13. The system of claim 12 wherein the redemption value includes a plurality of bids that can be used in bidding fee auctions.

14. The system of claim 9 wherein the one or more processors are further configured to provide an option to edit the listing.

15. The system of claim 14 wherein the option to edit the listing is not provided for a period of time after the listing has been generated.

16. The system of claim 15 wherein the option to edit the listing is not provided when the item has been reserved for purchase.

17. A non-transitory computer readable medium that stores a set of instructions that are executable by at least one processor of one or more computers to cause the one or more computers to offer items for sale, the set of instructions causing the one or more computers to:
provide a bidding fee auction for a item;
receive one or more bids for the item;
determine a winning bidder based on the received one or more bids;
generate a user interface providing the winning bidder:
a first option to purchase the item at a purchase price calculated based on the one or more bids, and
a second option to list the item for sale in an electronic marketplace;
receive a selection including the first option or the second option;
initiate payment processing for the item when the selection includes the first option;
generate a user interface requesting a listing price for the item when the selection includes the second option;
receive the listing price in response to generating the user interface requesting the listing price;
verify the received listing price; and
generate, based on the verification of the listing price, a listing including a description of the item and the listing price.

18. The non-transitory computer readable medium of claim 17 wherein the set of instructions further cause the one or more computers to:
receive a request to purchase the item at the listing price, and
initiate payment processing for the item based on the listing price.

19. The non-transitory computer readable medium of claim 17 wherein the set of instructions further cause the one or more computers to determine a redemption value to provide the winning bidder as a result of the sale of the item, wherein the redemption value includes a plurality of bids that can be used in bidding fee auctions.

20. The non-transitory computer readable medium of claim 17 wherein the set of instructions further cause the one or more computers to provide an option to edit the listing, wherein option to edit the listing is not provided for a period of time after the listing has been generated or when the item has been reserved for purchase.
